(19) United States
(12) Patent Application Publication
(10) Pub. No.: US 2008/0136198 A1
(43) Pub. Date: Jun. 12, 2008

(54) ADJUSTABLE BRACING DEVICE FOR HOLDING AN OPENABLE CASE IN AN OPENED POSITION

(75) Inventor: David Alan Barr, Arlington, TX (US)

Correspondence Address: DARBY & DARBY P.C., P.O. BOX 770, Church Street Station, New York, NY, 10008-0770, US

(73) Assignee: KIDKRAFT, LP., Arlington, TX (US)

(21) Appl. No.: 11/608,010

(22) Filed: Dec. 7, 2006

(51) Int. Cl. E05C 17/44

(52) U.S. Cl. 292/338

(57) ABSTRACT

An adjustable bracing device used for holding an openable case includes first and second mounts which respectively extend away from a case body and a hinged lid member of the case, and a carrier frame which is pivotally mounted to the first mount and a linking lever, and which has a biasing member mounted thereon. A cam surface of the linking lever is disposed to abut against a depressed end of the biasing member for holding the lid member in a partially or fully opened position. An adjusting member is disposed to adjust the biasing force of the biasing member.

### BACKGROUND OF THE INVENTION

1. Field of the Invention

This invention relates to an adjustable bracing device for holding an openable case, more particularly to an adjustable bracing device used for holding an openable case in a partially opened position.

2. Description of the Related Art

Referring to FIGS. 1 and 2, a conventional bracing device 1 is shown to be used for holding an openable case in a partially opened position. The openable case includes a case body 2 and a lid member 3. The case body 2 has an upright surrounding wall unit which extends upwardly to define an accommodation chamber 20 and to terminate at a surrounding end edge 22 that defines an access opening 24 to permit access to the accommodation chamber 20, and which has a left upright wall 23. The lid member 3 has a proximal edge 31 disposed to be hinged to the left upright wall 23 about a hinging axis, and a major wall 30 which extends from the proximal edge 31 to terminate at a distal edge 32, and which is configured to close the access opening 24.

The bracing device 1 includes first and second mounts 15,16 disposed to be secured to the left upright wall 23 and the major wall 30, respectively, a carrier frame 11 having an anchoring end 13 which is pivotally connected to the first mount 15, a linking end 16, and a guiding portion 18 for receiving a biasing member 12 therein, and a linking lever 14 having a power end 142 which is pivotally connected to the second mount 16, and a weight end 141 with a cam surface that is disposed to abut against an end of the biasing member 12 so as to place the biasing member 12 in a lightly or heavily compressed position to thereby deliver a smaller or larger biasing force such that the smaller or larger biasing force can counteract a smaller or larger torque for holding the lid member 3 in a fully or partially opened position. Thus, the lid member 3 can be opened to the fully opened position by the user, and can then be held in the partially opened position by the bracing device 1 to permit access to the accommodation chamber 20. However, since the biasing force of the biasing member 12 is fixed, it may not be sufficient to hold a relatively heavy lid member in the partially opened position, which may result in falling of the lid member. Moreover, the lid member may also fall as a result of metal fatigue of the biasing member 12 after a prolonged period of use.

### SUMMARY OF THE INVENTION

The object of the present invention is to provide an adjustable bracing device with an adjusting member which permit adjustment of the biasing force of a biasing member thereof.

According to this invention, the adjustable bracing device includes first and second mounts adapted to respectively extend away from a case body and a lid member hinged to the case body, a carrier frame, a biasing member, a linking lever, and an adjusting member. The first mount has a first pivot end pivotally mounted to an anchoring end of the carrier frame. The second mount has a second pivot end which is pivotally mounted to a power end of the linking lever, and which, as a result of displacement of the center of gravity of the lid member, delivers larger and smaller torques in a partially opened position and a fully opened position, respectively. The carrier frame includes a linking end pivotally mounted to a fulcrum of the linking lever, and a guiding segment interposed between the anchoring end and the linking end to define a lengthwise path. The biasing member is disposed on the guiding segment, and has abutment and depressed ends that are proximate to the anchoring end and the linking end, respectively. The biasing member is compressible along the lengthwise path between a heavily compressed position, where the depressed end is closer to the abutment end to thereby deliver a larger biasing force, and a lightly compressed position, where the depressed end is remote from the abutment end to thereby deliver a smaller biasing force. The linking lever has a weight end having a cam surface which includes first and second regions that are angularly displaced from each other, and that are distant from the fulcrum respectively by a first length and a second length which is shorter than the first length. When the second region is brought to abut against the depressed end so as to place the biasing member in the lightly compressed position, the smaller biasing force counteracts the smaller torque, thereby permitting the lid member to be held in the fully opened position by virtue of a balance of forces. Once a tipping force is applied to disrupt the balance of forces so as to cause the second pivot end to deliver the larger torque, the weight end is caused to turn about the fulcrum axis against the larger biasing force to bring the first region to abut against the depressed end to thereby place the biasing member in the heavily compressed position, where the larger biasing force counteracts the larger torque, thereby permitting the lid member to be held in the partially opened position. The adjusting member is disposed to adjust the position of the abutment end relative to the anchoring end so as to vary the biasing force of the biasing member.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a sectional view of a conventional bracing device incorporated in an openable case;

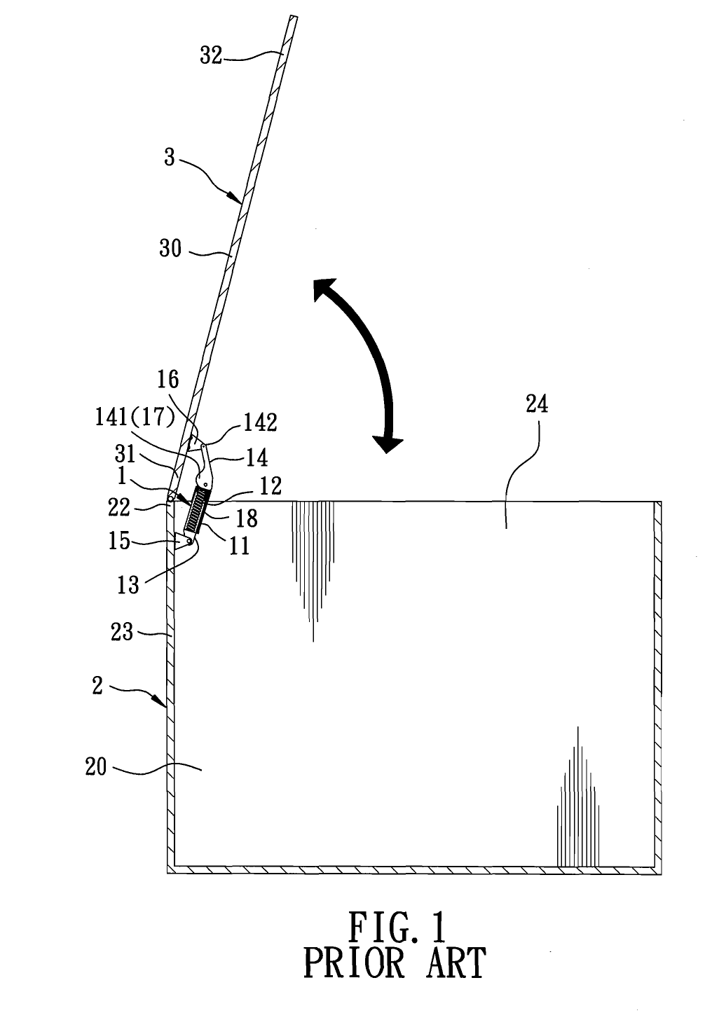

FIG. 2 is a sectional view illustrating how a lid member of the case, incorporating the conventional bracing device is held in a partially opened position;

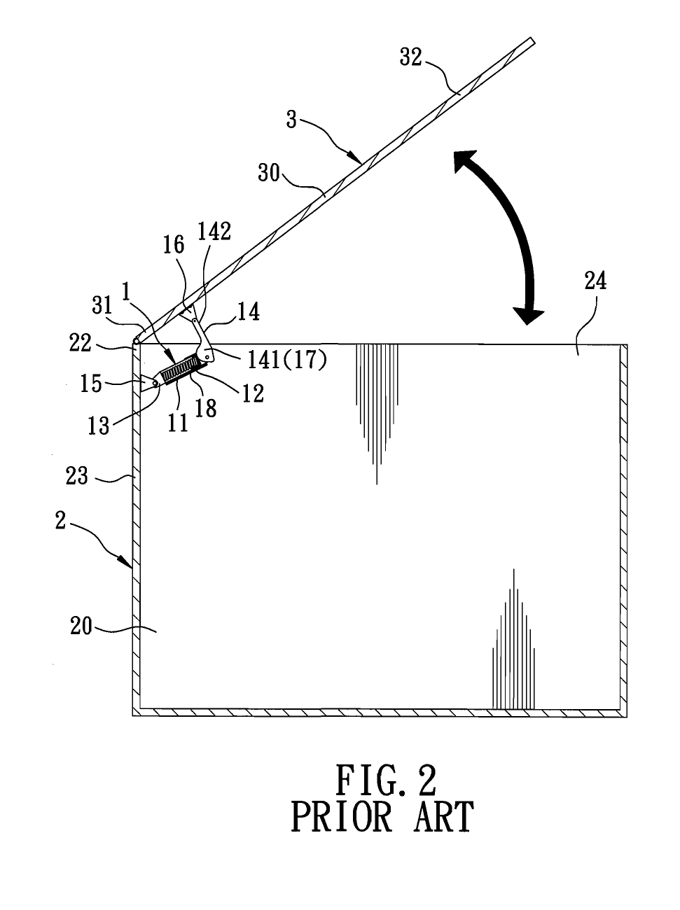

FIG. 3 is a perspective view of the preferred embodiment of an adjustable bracing device when mounted on an openable case according to this invention;

FIG. 4 is an exploded perspective view of the preferred embodiment;

FIG. 5 is a schematic sectional view showing how the adjustable bracing device holds a lid member of the case in a fully opened position; and

FIG. 6 is a schematic sectional view showing how the adjustable bracing device holds the lid member of the case in a partially opened position.

### DETAILED DESCRIPTION OF THE PREFERRED EMBODIMENT

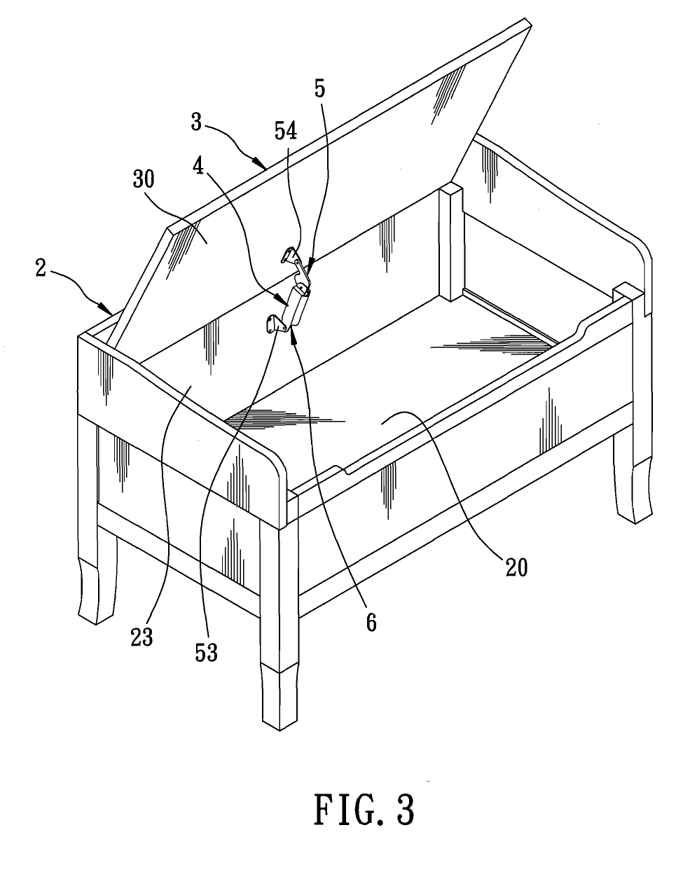

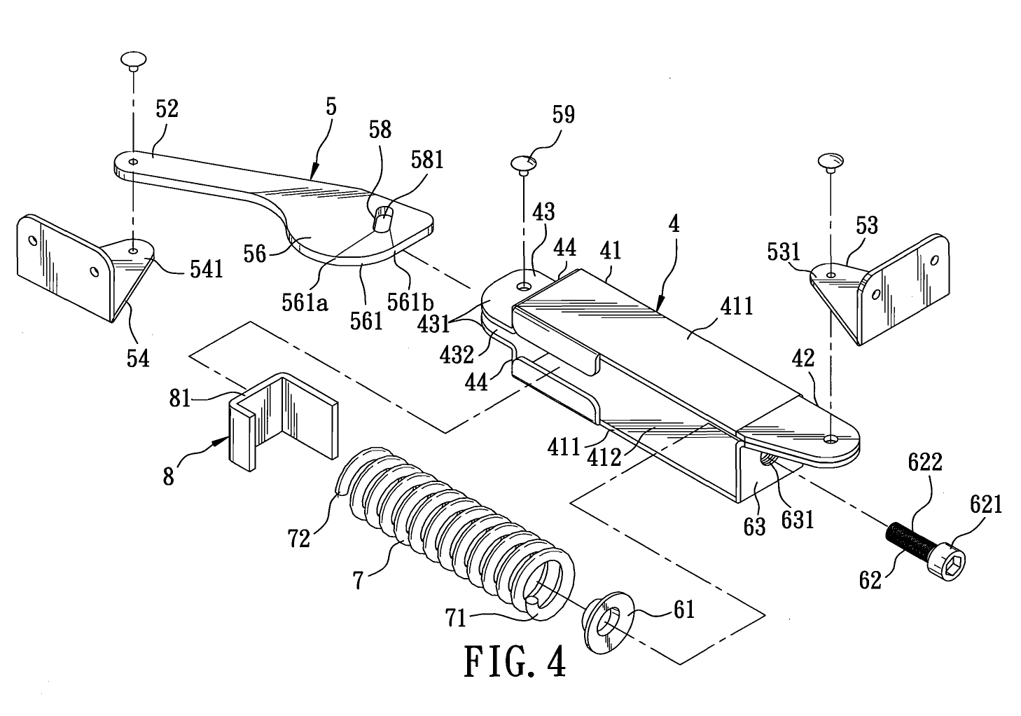

Referring to FIGS. 3 to 5, the preferred embodiment of an adjustable bracing device according to the present invention is shown to be used for holding an openable case in a partially opened position. The case includes a case body 2 and a lid member 3 hinged to an upright wall 23 of the case body 2 about a hinging axis extending in a transverse direction. The adjustable bracing device is shown to comprise a first mount 53, a second mount 54, a carrier frame 4, a biasing member 7, a linking lever 5, and an adjusting member 6.

The first mount 53 is adapted to be secured on the upright wall 23 of the case body 2, and extends away from the upright wall 23 to terminate at a first pivot end 531. The second mount 54 is adapted to be secured on a major wall 30 of the lid member 3, and extends away from the major wall 30 to terminate at a second pivot end 541 which, as a result of displacement of the center of gravity of the lid member 3 when the lid member 3 is moved between the partially opened position and a fully opened position, delivers larger and smaller torques, respectively.

The carrier frame 4 includes an anchoring end 42 pivotally mounted on the first pivot end 531 of the first mount 53 about a first pivot axis parallel to the hinging axis, a linking end 43 opposite to the anchoring end 42, and a guiding segment 41 interposed between the anchoring end 42 and the linking end 43 to define a lengthwise path. The linking end 43 is configured to have two lug portions 431 which are spaced apart from each other in the transverse direction to define an accommodation space 432. The guiding segment 41 is configured to have two guiding walls 411 which are spaced apart from each other in the transverse direction to define an accommodation chamber 412 that extends along the lengthwise path. Two shoulder walls 44 extend in the transverse direction to respectively interconnect the lug portions 43 and the guiding walls 411.

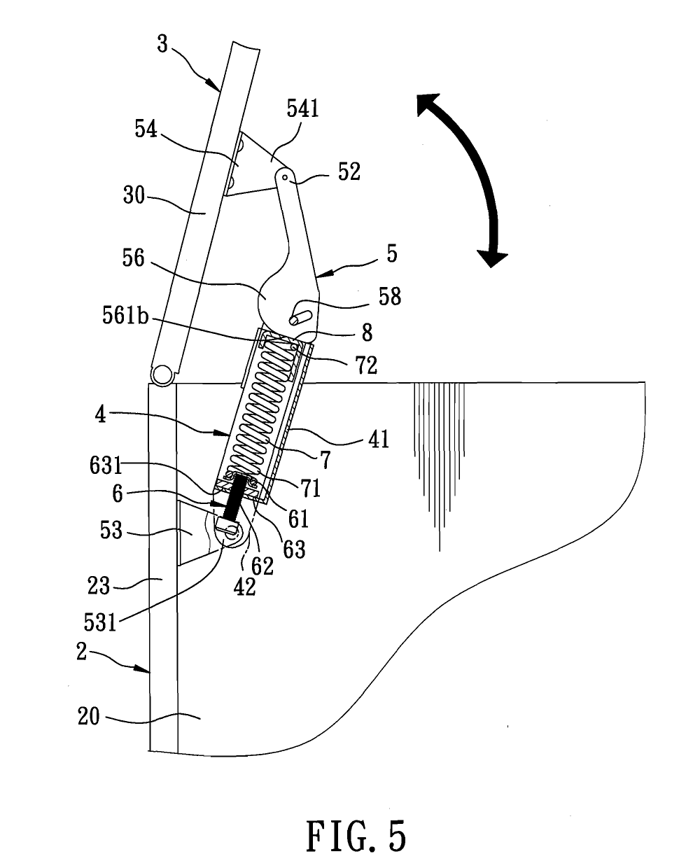

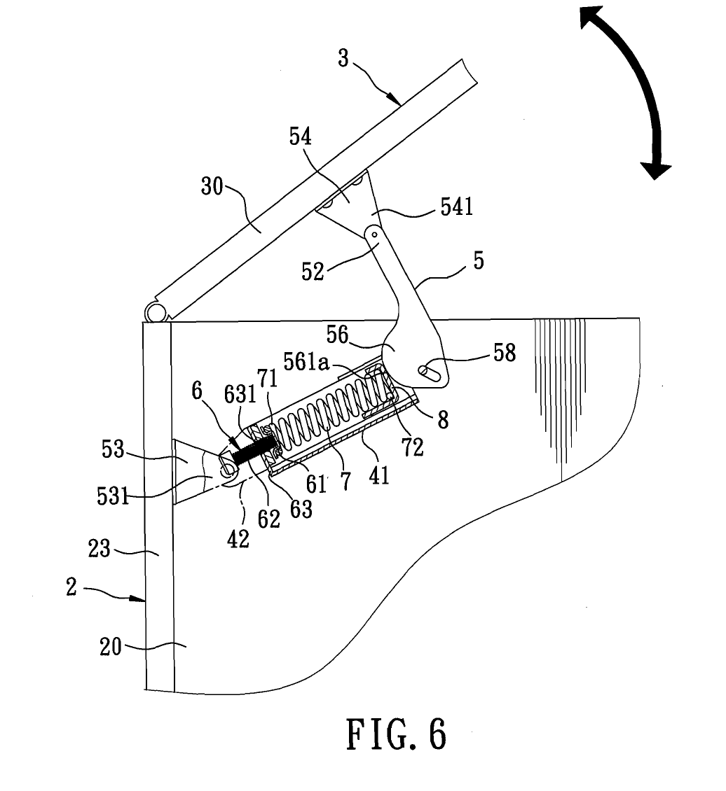

The biasing member 7 is received in the accommodation chamber 412, extends along the lengthwise path, and has abutment and depressed ends 71, 72 which are opposite to each other, and which are proximate to the anchoring end 42 and the linking end 43, respectively. The biasing member 7 is configured to be compressible along the lengthwise path between a heavily compressed position, as shown in FIG. 6, where the depressed end 72 is closer to the abutment end 71 to thereby deliver a larger biasing force, and a lightly compressed position, as shown in FIG. 5, where the depressed end 72 is remote from the abutment end 71 to thereby deliver a smaller biasing force.

The linking lever 5 includes a power end 52 which is pivotally mounted on the second pivot end 541 of the second mount 54 about a second pivot axis parallel to the first pivot axis, and a fulcrum 58 which is pivotally mounted on the linking end 43 about a fulcrum axis parallel to the first pivot axis by means of a linkage pin 59 that extends through the lug portions 43 and that is received loosely in a key slot 581 formed in the fulcrum 58 so as to permit the fulcrum 58 to vary in location for facilitating a smooth angular displacement of the linking lever 5. The linking lever 5 further includes a weight end 56 which is received in the accommodation space 432, and which has a cam surface 561. The cam surface 561 includes first and second regions (561a, 561b) which are angularly displaced from each other about the fulcrum axis, and which are distant from the fulcrum axis by a first length and a second length, respectively. The second length is shorter than the first length. A pressure transmitting member 8 has a major wall 81 which is interposed between the depressed end 72 of the biasing member 7 and the shoulder walls 44. Thus, as shown in FIG. 5, when the second region (561b) is brought to abut against the depressed end 72 of the biasing member 7 via the major wall 81 of the pressure transmitting member 8 so as to place the biasing member 7 in the lightly compressed position, the smaller biasing force of the depressed end 72 counteracts the smaller torque delivered by the second pivot end 541, thereby permitting the lid member 3 to be held in the fully opened position by virtue of a balance of forces. In addition, as shown in FIG. 6, once the balance of forces is disrupted by a tipping force, the second pivot end 541 is caused to deliver the larger torque, and the weight end 56 is caused to turn about the fulcrum axis against the larger biasing force to bring the first region (561a) to abut against the depressed end 72 via the major wall 81 of the pressure transmitting member 8 to thereby place the biasing member 7 in the heavily compressed position, where the larger biasing force of the depressed end 72 counteracts the larger torque delivered by the second pivot end 541, thereby permitting the lid member 3 to be held in the partially opened position to allow access to the accommodation chamber 20 in the case body 2. The provision of the force transmitting member 8 facilitates the forced displacement of the depressed end 72 of the biasing member 7 from the second region (561b) to the first region (561a). The shoulder walls 44 cooperatively serve as a limiting barrier to the force transmitting member 8 and the depressed end 72 of the biasing member 7.

The adjusting member 6 includes an abutment wall 63, an end cap 61, and an adjustment screw 62. The abutment wall 63 is disposed proximate to the anchoring end 42 of the carrier frame 4 to confront and cooperate with both the shoulder walls 44 to define the lengthwise path, and has a screw hole 631 formed therethrough. The end cap 61 is detachably engaged with the abutment end 71 of the biasing member 7, and has a pushed surface which is disposed to abut against the abutment wall 63. The adjustment screw 62 has a head portion 621 and a threaded shank portion 622 opposite to the head portion 621. The threaded shank portion 622 is threadedly engaged in the screw hole 631 so as to be movable between an adjusted position, where the abutment end 71 of the biasing member 7 is closer to the depressed end 72 as a result of a screw-in movement of the threaded shank portion 622 to push the pushed surface of the end cap 61 by virtue of turning of the head portion 621 using a tool (not shown), and an unadjusted position, where the abutment end 71 is remote from the depressed end 72. When the lid member 3 is relatively heavy, or when the biasing member 7 suffers from metal fatigue, the user can turn the head portion 621 to move the threaded shank portion 622 from the unadjusted position to the adjusted position so that the position of the abutment end 71 relative to the anchoring end 42 is adjusted to thereby increase the biasing force of the biasing member 7. Thus, the lid member 3 can be held firmly in the partially opened position. On the contrary, if the user needs to apply a relatively large force to the lid member 3 in order to counteract the biasing force of the biasing member 7 when closing the lid member 3, the user can screw-out the adjustment screw 62 so as to move the abutment end 71 away from the depressed end 72, thereby decreasing the biasing force of the biasing member 7. While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. An adjustable bracing device used for holding an openable case in a partially opened position, the openable case including an upright wall and a lid member which has a proximate edge hinged to the upright wall about a hinging axis, and a major wall extending from the proximate edge, said adjustable bracing device comprising:
a first mount adapted to extend away from the upright wall to terminate at a first pivot end;
a second mount adapted to extend away from the major wall to terminate at a second pivot end which, as a result of displacement of a center of gravity of the lid member in the partially opened position and a fully opened position, delivers larger and smaller torques, respectively;
a carrier frame including an anchoring end pivotally mounted on said first pivot end about a first pivot axis parallel to the hinging axis, a linking end opposite to said anchoring end, and a guiding segment interposed between said anchoring end and said linking end to define a lengthwise path;
a biasing member which is disposed on said guiding segment, and which has abutment and depressed ends that are opposite to each other, and that are proximate to said anchoring end and said linking end respectively, said biasing member being configured to be compressible along the lengthwise path between a heavily compressed position, where said depressed end is closer to said abutment end to thereby deliver a larger biasing force, and a lightly compressed position, where said depressed end is remote from said abutment end to thereby deliver a smaller biasing force;
a linking lever including
a power end pivotally mounted on said second pivot end about a second pivot axis parallel to the first pivot axis,
a fulcrum pivotally mounted on said linking end about a fulcrum axis parallel to the first pivot axis, and
a weight end having a cam surface which includes first and second regions that are angularly displaced from each other about the fulcrum axis, and that are distant from the fulcrum axis by a first length and a second length, respectively, the second length being shorter than the first length, said first and second regions being configured such that when said second region is brought to abut against said depressed end so as to place said biasing member in the lightly compressed position, the smaller biasing force counteracts the smaller torque, thereby permitting the lid member to be held in the fully opened position by virtue of a balance of forces, and such that once a tipping force is applied to disrupt the balance of forces so as to cause said second pivot end to deliver the larger torque, said weight end is caused to turn about the fulcrum axis against the larger biasing force to bring said first region to abut against said depressed end to thereby place said biasing member in the heavily compressed position, where the larger biasing force counteracts the larger torque, thereby permitting the lid member to be held in the partially opened position; and
an adjusting member disposed to adjust the position of said abutment end relative to said anchoring end so as to vary the biasing force of said biasing member.

2. The adjustable bracing device according to claim 1, wherein said adjusting member includes an abutment wall which is disposed proximate to said anchoring end, an end cap which has a pushed surface that is disposed to abut against said abutment wall, and an adjustment screw which has a head portion and a threaded shank portion opposite to said head portion, and which is configured to be in a threaded engagement with said abutment wall such that said threaded shank portion is movable between an adjusted position, where said abutment end of said biasing member is closer to said depressed end as a result of a screw-in movement of said threaded shank portion to push said pushed surface by virtue of turning of said head portion, and an unadjusted position, where said abutment end is remote from said depressed end.

3. The adjustable bracing device according to claim 2, wherein said linking end is configured to have two lug portions which are spaced apart from each other along the fulcrum axis to define an accommodation space to receive said weight end, said adjustable bracing device further comprising a linkage pin which extends through said lug portions along the fulcrum axis to pivot said fulcrum so as to permit one of said first and second regions to abut against said depressed end.

4. The adjustable bracing device according to claim 3, wherein said carrier frame includes two guiding walls which are spaced apart from each other in a transverse direction parallel to the fulcrum axis to define an accommodation chamber that extends along the lengthwise path to serve as said guiding segment.

5. The adjustable bracing device according to claim 4, wherein said carrier frame includes two shoulder walls which extend in the transverse direction and each of which interconnects one of said lug portions and a respective one of said guiding walls, said shoulder walls cooperatively serve as a limiting barrier to said depressed end.

6. The adjustable bracing device according to claim 5, further comprising a pressure transmitting member which has a major wall that is interposed between said depressed end and at least one of said shoulder walls to facilitate the turning of said weight end about the fulcrum axis.

7. The adjustable bracing device according to claim 6, wherein said abutment wall confronts said shoulder walls and cooperates with said shoulder walls to define said lengthwise path.

8. The adjustable bracing device according to claim 2, wherein said end cap is detachably engaged with said abutment end of said biasing member.

9. The adjustable bracing device according to claim 3, wherein said linking lever has a key slot configured to loosely receive said linkage pin so as to permit said fulcrum to vary in location.
